(19) United States
(12) Patent Application Publication
(10) Pub. No.: US 2008/0018921 A1
(43) Pub. Date: Jan. 24, 2008

(54) Image forming processing apparatus and method, and recording medium storing image forming processing program

(75) Inventor: Kiyoshi Hori, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/879,532

(22) Filed: Jul. 18, 2007

(30) Foreign Application Priority Data
Jul. 20, 2006 (JP) 2006-198620

(51) Int. Cl. H04N 1/60

(52) U.S. Cl. 358/1.9

(57) ABSTRACT

An image forming processing apparatus includes: an image processor which synthesizes a latent image embedded background image data concerning a latent image embedded background image which is embedded with a mask image capable of keeping invisible in the process of printing but becoming visible in the process of copying as a latent image and a primary image data concerning a primary image into output data; and a controller which determines whether or not a synthesizing mode of synthesizing the latent image embedded background image and the primary image is set, and controls the image processor to synthesize the primary image data and the latent image embedded background image data without any superimposition of the primary image and the latent image embedded background image when the synthesizing mode is set.

### BACKGROUND OF THE INVENTION

1. Field of the Invention

The present invention relates to an image forming processing apparatus and method of synthesizing a latent image embedded background image embedded with a mask image as a latent image and a primary image into output image and a recording medium storing an image forming processing program.

2. Description of the Related Art

In recent years, the image quality of a copy has been enhanced in accordance with the development of a copying technology, and it became possible to obtain a copy which is almost identical to an original document. However, on the other hand, there has been a problem of unauthorized use of a copy. Accordingly, a technology has been requested which distinguishes a copy from an original document.

For example, there has been used an anti-forgery sheet on which a special pattern is printed in advance. The special pattern enables hidden warning letters and the like to be visible on a copy in the process of copying the sheet with a copying machine. Further, there has been used an anti-forgery sheet embedded with a serial number as a latent image.

However, in a case where a design of a background pattern, a logo, a symbol mark and the like of such anti-forgery paper needs to be changed, it is required to start over printing the design onto the paper. Accordingly, there has been a problem that time and costs are taken.

Further, there has been an image forming apparatus in which a latent image embedded background image embedded with warning letters and a serial number as a latent image and a primary image are synthesized into output image.

In this image processing apparatus, warning letters and the like which are embedded as a latent image are applied with a halftone-dot processing of making the number of lines be less than that of the number of outputted lines and outputted. Accordingly, the halftone-dotted portion is reproduced faithfully in the process of reading with a copier, and the warning letters and the like become visible on a copy prominently.

However, in a case where a latent image embedded background image and a primary image are synthesized into output image, the printing result is obtained as shown in FIG. 12 where a latent image embedded background image BI and a primary image MI are superimposed. In such case, a latent image pattern is printed on a whole area of a sheet. Accordingly, there is a likelihood that the appearance of a printed image becomes unfavorable, especially in a case of a color printing.

Further, when print data of a primary image MI′ covers a whole area of an output sheet as shown in FIG. 13, the primary image MI′ and a latent image embedded background image BI′ cannot be synthesized without deterioration of image quality of the primary image MI′.

### SUMMARY OF THE INVENTION

An image forming processing apparatus according to one aspect of the present invention comprises: an image processor which synthesizes a latent image embedded background image data concerning a latent image embedded background image which is embedded with a mask image capable of keeping invisible in the process of printing but becoming visible in the process of copying as a latent image and a primary image data concerning a primary image into output data; and a controller which determines whether or not a synthesizing mode of synthesizing the latent image embedded background image and the primary image is set, and controls the image processor to synthesize the primary image data and the latent image embedded background image data without any superimposition of the primary image and the latent image embedded background image when the synthesizing mode is set.

These and other objects, features, and advantages of the present invention will become more apparent upon reading of the following detailed description along with the accompanied drawings.

### BRIEF DESCRIPTION OF THE DRAWINGS

FIG. 1 is a block diagram showing a printing system including an image forming apparatus and a client according to a first embodiment of the present invention.

FIG. 2 is a block diagram showing a hardware configuration of the client shown in FIG. 1.

FIG. 3 is a block diagram showing a hardware configuration of the image forming apparatus shown in FIG. 1.

FIG. 4 is a block diagram showing functional configurations of the client and the image forming apparatus shown in FIG. 1.

FIG. 5 is a flowchart showing steps of printing processing in the printing system shown in FIG. 1.

FIG. 6 schematically shows an example of the printing processing performed by the image forming apparatus shown in FIG. 1.

FIG. 7 is a block diagram showing a functional configuration of a printing system according to a second embodiment of the present invention.

FIG. 8 is a flowchart showing a printing processing of the image forming apparatus shown in FIG. 7.

FIG. 9 shows an example of a printing result in a case where a latent image embedded background image and a primary image are synthesized in the system shown in FIG. 7.

FIG. 10 shows another example of a printing result in a case where a latent image embedded background image and a primary image are synthesized in the system shown in FIG. 7.

FIG. 11 shows yet another example of a printing result in a case where a latent image embedded background image and a primary image are synthesized in the system shown in FIG. 7.

FIG. 12 shows an example of a basic printing result in a case where a latent image embedded background image embedded with a mask image as a latent image and a primary image are synthesized.

FIG. 13 shows an example of a printing result in a case where a print data of a primary image covers a whole area of an output sheet.

### DETAILED DESCRIPTION OF THE PREFERRED EMBODIMENTS

Hereinafter, embodiments of the present invention will be described in detail with reference to the drawings. It goes without saying that the present invention is not limited to the following examples, and it can be modified within a range of not departing from a gist of the present invention.

### First Embodiment

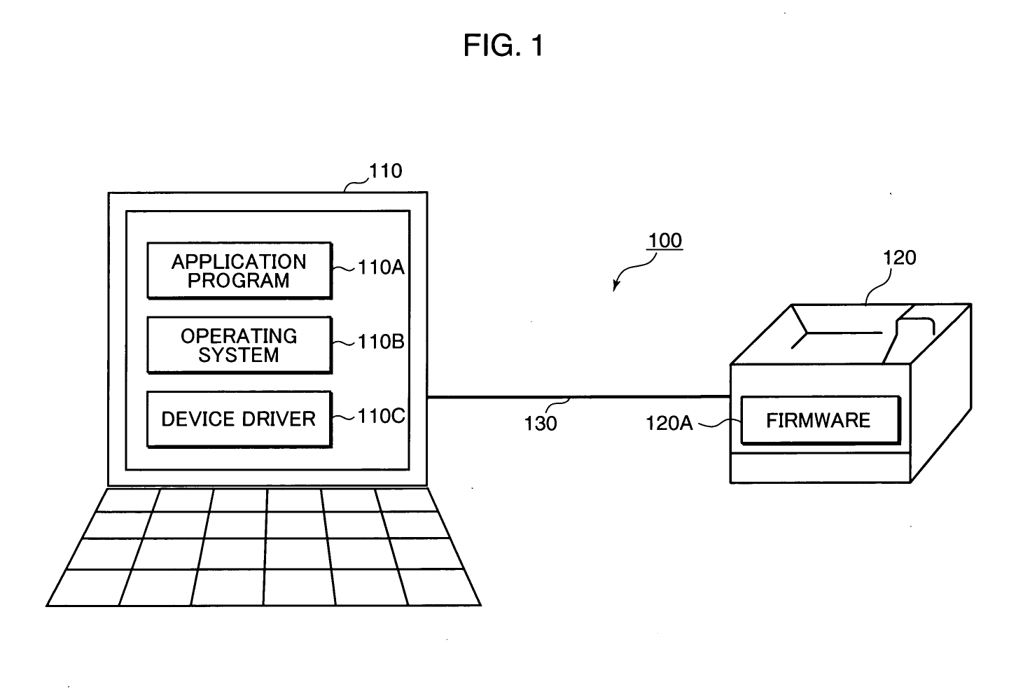

As shown in FIG. 1, the present invention may be adopted in a printing system 100 including a client 110 which allows a user to input a printing instruction and an image forming apparatus (printing machine) 120 which are communicable with each other via a network 130 such as a LAN. The image forming apparatus 120 may be directly connected to the client 110 via a USB interface or a parallel interface without being connected to the network 130.

The client 110 is composed of so called personal computer in which various programs including an application program 110A, an operating system 110B and a device driver 110C are installed. The image forming apparatus 120 is composed of so called complex machine in which various programs including a firmware 120A are installed. The image forming apparatus 120 is not especially limited to this example but may be various apparatuses such as a printer, a facsimile machine and a copier capable of printing an image onto an output sheet.

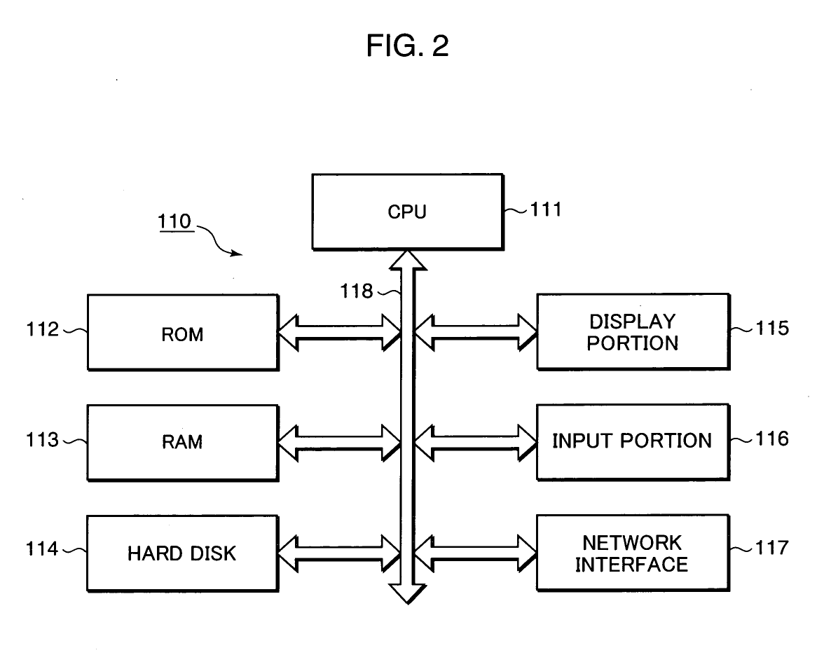

FIG. 2 is a block diagram showing a hardware configuration of the client 110 shown in FIG. 1. As shown in FIG. 2, the client 110 includes a CPU 111, a ROM 112, a RAM 113, a hard disk drive 114, a display portion 115, an input portion 116 and a network interface 117 which are connected with each other via a bus 118. The CPU 111 controls a whole apparatus and performs various arithmetic processing. The ROM 112 stores the application program 110A, the operating system 110B, the device driver 110C, data and the like. The RAM 113 serves as a working area for temporarily storing programs and data. The hard disk drive 114 serves as an external memory device for storing various programs and data. The display portion 115 such as a liquid crystal display displays various information. The input portion 116 includes a keyboard and a mouse for allowing a user to input various instructions. The network interface 117 such as a LAN card connects the client 110 to the network 130 shown in FIG. 1.

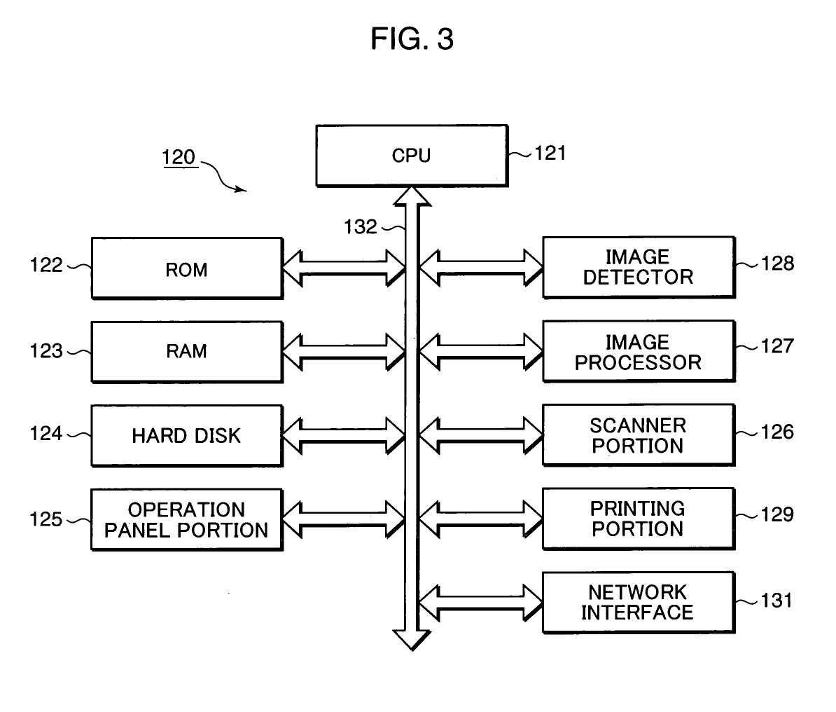

FIG. 3 is a block diagram showing a hardware configuration of the image forming apparatus shown in FIG. 1. As shown in FIG. 3, the image forming apparatus 120 includes a CPU 121, a ROM 122, a RAM 123, a hard disk drive 124, an operation panel portion 125, a scanner portion 126, an image processor 127, an image detector 128, a printing portion 129 and a network interface 131 which are connected with each other via a bus 132. The CPU 121 controls over a whole apparatus and performs various arithmetic processing. The ROM 122 stores various programs such as the firmware 120A and the like and data. The RAM 123 serves as a working area and temporarily stores programs and data. The hard disk drive 124 serves as an external memory device for storing various programs and data. The operation panel portion 125 displays various information and allows a user to input various instructions. The scanner portion 126 reads out a document. The image processor 127 creates an image data which corresponds to an image of the document read out in the scanner portion 126. The image detector 128 detects a predetermined image included in a document read out in the scanner portion 126. The printing portion 129 prints various data onto a recording member such as a recording sheet with use of a known image forming processing such as an electrophotographic processing. The network interface 131 such as a LAN card connects the image forming apparatus 120 to the network 130.

The client 110 performs a document processing of creating a document in accordance with the application program 110A. The device driver 110C serves to synthesize a latent image embedded background image data with a primary image data received from the operating system 110B.

Here, the primary image includes an image which is a subject to be printed. The latent image embedded background image includes a background image embedded with a mask image as a latent image. For example, the latent image embedded the background image is created by applying a halftone-dot processing to a character pattern of the mask image and embedding the same into the background image. Further, the mask image is an image embedded in a background image and is capable of keeping invisible in the process of printing but becoming visible in the process of copying. The mask image includes a document tracking information image concerning document tracking information for tracking an origin of a primary image and copy control information concerning information for controlling copying.

For example, in a case where a character pattern of a person who executes printing is depicted as a mask image, the character pattern becomes a latent image pattern embedded in a background image. Since a portion of the mask image embedded as a latent image is applied with a halftone-dot processing with the number of lines less than that of the number of outputted lines, the halftone-dot portion is faithfully reproduced in the process of reading out a printed latent image embedded background image with a copying machine and the character pattern prominently appears as a mask image in a copy.

In the printing system 100, the client 110 transmits a file data described in a PDL (Page Description Language) to the image forming apparatus 120. The image forming apparatus 120 directly prints out the file data described in PDL. When a latent image embedded background image data and a primary image data are synthesized, the device driver 110C in the client 110 applies reduction processing to the main data received from the operating system 110B and then synthesizes the primary image data and the latent image embedded background image into output data. Thereafter, the device driver 110C transmits the output data to the image forming apparatus as PDL data to be printed.

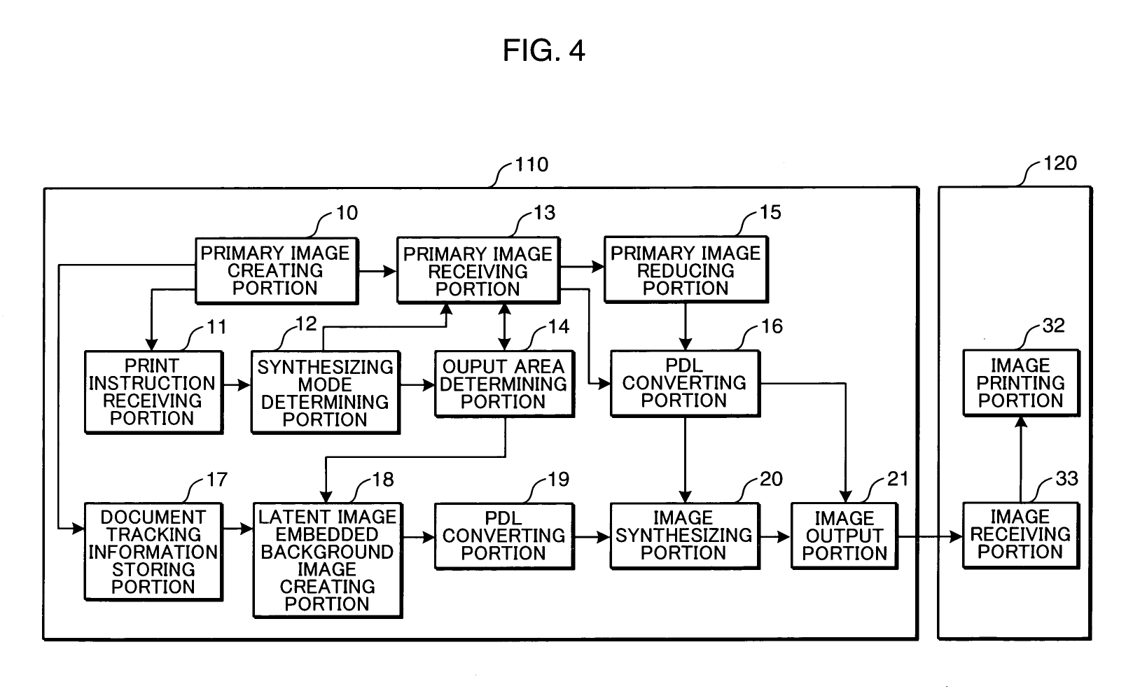

FIG. 4 is a block diagram showing a hardware configurations of the client 110 and the image forming apparatus 120 shown in FIG. 1. As shown in FIG. 4, the client 110 includes a primary image creating portion 10, a print instruction receiving portion 11, a synthesizing mode determining portion 12, a primary image receiving portion 13, an output area determining portion 14, a primary image reducing portion 15, a PDL converting portion 16, a document tracking information storing portion 17, a latent image embedded background image creating portion 18, a PDL converting portion 19, an image synthesizing portion 20 and an image output portion 21. The image forming apparatus 120 includes an image printing portion 32 and an image receiving portion 33. The image receiving portion 33 includes the CPU 121 and the network interface 131 shown in FIG. 3, and the image printing portion 32 includes the CPU 121 and the printing portion 129 shown in FIG. 3.

Here, the CPU 111 shown in FIG. 2 executes the application program 110A, the operating system 110B shown in FIG. 1 and the like, so that client 110 serves as the primary image creating portion 10. Further, the CPU 111 shown in FIG. 2 executes the device driver 110C shown in FIG. 1 and the like, so that client 110 serves as the print instruction receiving portion 11, the synthesizing mode determining portion 12, the primary image receiving portion 13, the output area determining portion 14, the primary image reducing portion 15, the PDL converting portion 16, the document tracking information storing portion 17, the latent image embedded background image creating portion 18, the PDL converting portion 19, the image synthesizing portion 20 and the image output portion 21.

The image creating portion 10 creates a primary image data and thereafter outputs a print instruction to allow the print instruction receiving portion 11 to start printing and outputs the primary image data to the primary image receiving portion 13. The print instruction includes synthesizing mode setting information indicating whether or not the synthesizing mode is set. Further, the primary image creating portion 10 creates document tracking information corresponding to the primary image data and allows the document tracking information storing portion 17 to store the document tracking information.

When the print instruction receiving portion 11 receives the print instruction, it extracts synthesizing mode setting information from the print instruction and outputs the same to the synthesizing mode synthesizing mode determining portion 12. The synthesizing mode determining portion 12 determines whether or not the synthesizing mode of synthesizing the latent image embedded background image and the primary image is set based on the synthesizing mode setting information.

When the synthesizing mode is not set, the synthesizing mode determining portion 12 instructs the primary image receiving portion 13 to output the primary image data to the PDL converting portion 16. The primary image receiving portion 13 outputs the primary image data to the PDL converting portion 16 and instructs the PDL converting portion 16 to output a PDL data to the image output portion 21. The PDL converting portion 16 converts the primary image data into a PDL data and outputs the PDL data to the image output portion 21. The image output portion 21 transmits the PDL data of the primary image to the image receiving portion 33. The image receiving portion 33 of the image forming apparatus 120 receives the PDL data of the primary image and outputs the PDL data to the image printing portion 32. The image printing portion 32 prints the primary image onto an output sheet.

On the other hand, when the synthesizing mode is set, the synthesizing mode determining portion 12 notifies the output area determining portion 14 that the synthesizing mode is set and instructs the primary image receiving portion 13 to output the primary image data to the output area determining portion 14. The output area determining portion 14 determines whether or not the primary image covers a whole area of a printable area of an output sheet based on the primary image data received from the image receiving portion 13.

When the primary image does not cover a whole area of a printable area of the output sheet, the output area determining portion 14 instructs the primary image receiving portion 13 to output the primary image data to the PDL converting portion 16, and instructs the latent image embedded background image creating portion 18 to create a latent image embedded background image data.

At this time, the primary image receiving portion 13 outputs the primary image data to the PDL converting portion 16, and instructs the PDL converting portion 16 to output a PDL data to the image synthesizing portion 20. The PDL converting portion 16 converts the primary image into a PDL data and outputs the PDL data to the image synthesizing portion 20.

Further, in a case where the image is a text document, the primary image creating portion 10 allows the document tracking information storing portion 17 to store document tracking information of the text document, such as a name of the text document, a printing date, a person who executed the printing and an address (for example, a MAC address) of the client 110. The latent image embedded background image creating portion 18 refers to the document tracking information storing portion 17 and reads out the document tracking information. Then, the latent image embedded background image creating portion 18 creates a mask image including the document tracking information and a latent image embedded background image data of a background image which is embedded with the created mask image as a latent image and then outputs the data to the PDL converting portion 19. The PDL converting portion 19 converts the latent image embedded background image data into a PDL data and outputs the same to the image synthesizing portion 20.

At this time, the image synthesizing portion 20 adds the PDL data of the latent image embedded background image to the PDL data of the primary image and outputs the same to the image output portion 21. The image output portion 21 transmits the PDL data of the primary image which is added with the PDL data of the latent image embedded background image to the image receiving portion 33. The image receiving portion 33 of the image forming apparatus 120 receives the PDL data of the primary image which is added with the PDL data of the latent image embedded background image and outputs the same to the image printing portion 32. The image printing portion 32 prints the primary image and the latent image embedded background image onto an output sheet.

On the other hand, in a case where the primary image covers a whole area of a printable area of an output sheet, the output area determining portion 14 instructs the primary image receiving portion 13 to output the primary image data to the primary image reducing portion 15, and instructs the latent image embedded background image creating portion 18 to create a latent image embedded background image data.

At this time, the primary image receiving portion 13 outputs the primary image data to the primary image reducing portion 15. The primary image reducing portion 15 reduces the primary image data at a predetermined reduction rate and outputs the same to the PDL converting portion 16. Further, the image reducing portion 15 instructs the PDL converting portion 16 to output the PDL data to the image synthesizing portion 20. The PDL converting portion 16 converts the reduced primary image data into a PDL data and outputs the PDL data to the image synthesizing portion 20.

Further, the latent image embedded background image creating portion 18 refers to the document tracking information storing portion 17 and reads out document tracking information and to create a mask image including the document tracking information. Then, the latent image embedded background image creating portion 18 creates latent image embedded background image data concerning a background image which is embedded with the created mask image as a latent image and outputs the same to the PDL converting portion 19. The PDL converting portion 19 converts the latent image embedded background image data into a PDL data and outputs the PDL data to the image synthesizing portion 20.

At this time, the image synthesizing portion 20 adds the PDL data of the latent image embedded background image to the PDL data of the reduced primary image and outputs these PDL data to the image output portion 21. The image output portion 21 transmits to the image receiving portion 33 the PDL data of the reduced primary image which is added with the PDL data of the latent image embedded background image. The image receiving portion 33 of the image forming apparatus 120 receives the PDL data of the reduced primary image which is added with the PDL data of the latent image embedded background image, and outputs the PDL data to the image printing portion 32. The image printing portion 32 prints the reduced primary image and the latent image embedded background image onto the output sheet.

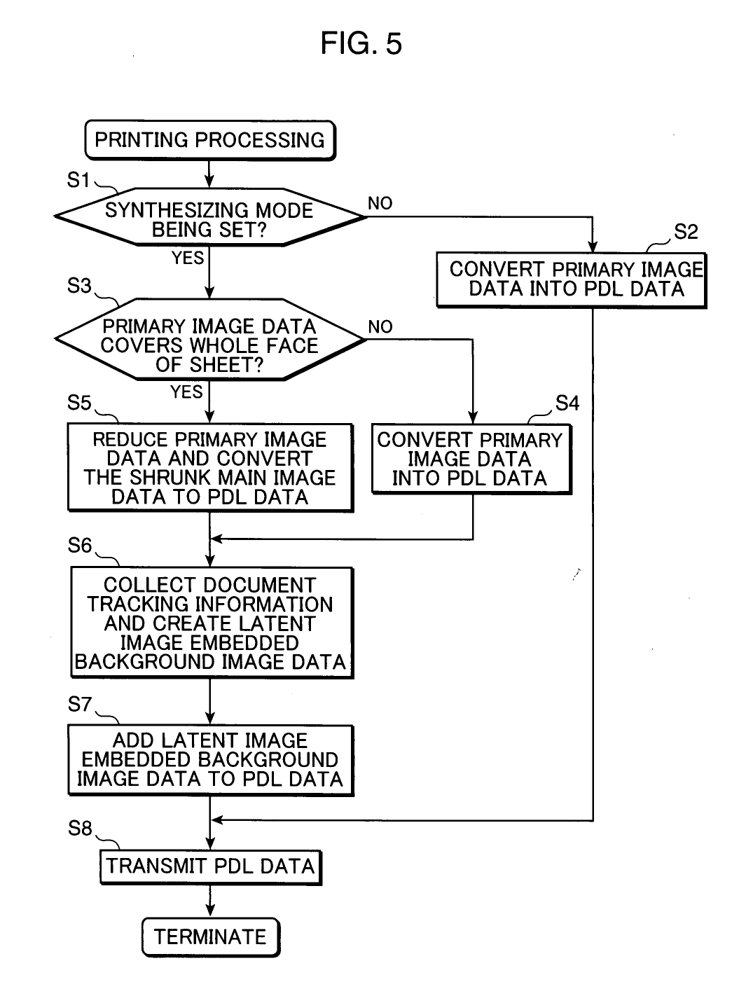

According to the above-described configuration, the CPU 111 of the client 110 in the printing system 100 executes the document processing in accordance with the application program 110A to determine whether or not a printing instruction in accordance with the document processing is received. When the CPU 111 receives the printing instruction, it executes a printing processing (image forming processing) in the steps shown in the flowchart of FIG. 5 in accordance with the device driver 110C.

Specifically, at first in step SI, when the CPU 111 of the client 110 starts the printing processing, it allows the synthesizing mode determining portion 12 to determine whether or not the synthesizing mode of synthesizing the latent image embedded background image and the primary image data is set.

In a case where the determination result in step S1 is “NO”, in other words, the synthesizing mode is not set, the PDL converting portion 16 converts the primary image data (document data) received from the operating system 110B directly into PDL data in the next step S2. Then, the routine proceeds to step S8.

Further, in a case where the determination result in the above-described step S1 is “YES”, in other words, the synthesizing mode is set, the output area determining portion 14 determines in step S3 whether or not the primary image data (document data) received from the operating system 110B covers a whole area of an output sheet.

In a case where the determination result in step S3 is “NO”, in other words, the primary image data (document data) does not cover a whole area but a part of the output sheet, the PDL converting portion 16 converts in the next step S4 the primary image data (document data) received from the operating system 110B directly into PDL data. Then, the routine proceeds to step S6.

On the other hand, in a case where the determination result in the step S3 is “YES”, in other words, the primary image data (document data) covers a whole area of the output sheet, the primary image reducing portion 15 reduces in step S5 the primary image data (document data) received from the operating system 110B, and the PDL converting portion 16 converts the reduced primary image data (document data) into PDL data. Then, the routine proceeds to step S6.

Here, the reduction rate of the primary image data may adopt various values such as 86%, 82%, 71%, and 50%, and one reduction rate out of these reduction rates is predetermined. The primary image data is reduced at the predetermined reduction rate. A setting of the reduction rate is not especially limited to the above-described examples. A user can set a desirable reduction rate through the input portion 116 or allow the reduction rate to be automatically calculated such that the primary image and the latent image embedded background image do not superimpose with each other.

In step S6, the latent image embedded background image creating portion 18 collects information such as a document name, a printing date, a person who executed the printing and an address of a client and creates a latent image embedded background image data concerning a background image which is embedded with a document tracking information image of visualized document tracking information as document tracking information. The document tracking information image is not especially limited to the above-described example. Any other various information can be used as long as it is information operable to specify a created document. For example, identification information and the like which is unique for each document can be used.

In the next step S7, the PDL converting portion 19 converts a latent image embedded background image data into a PDL data. The image synthesizing portion 20 adds the PDL data of the latent image embedded background image to the PDL data of the primary image, and synthesizes the latent image embedded background image data and the reduced primary image data. Specifically, the image synthesizing portion 20 synthesizes the latent image embedded background image and the reduced primary image data without any superimposition of the latent image embedded background image and the reduced primary image in a printable area of an output sheet. For example, a center position of the reduced primary image is made come to a central position of the output sheet, and a frame-like margin is provided in a periphery of the output sheet. The latent image embedded background image data and the primary image are synthesized such that the latent image embedded background image is formed in the margin portion.

In the next step S8, the image output portion 21 transmits the PDL data to the image forming apparatus 120. Then, the printing processing is terminated. Thereafter, the image receiving portion 33 of the image forming apparatus 120 receives the PDL data. The image printing portion 32 forms the reduced primary image at a central portion of the output sheet in accordance with the PDL data without any superimposition of the reduced primary image and the latent image embedded background image and forms the latent image embedded background image in a peripheral portion of the output sheet.

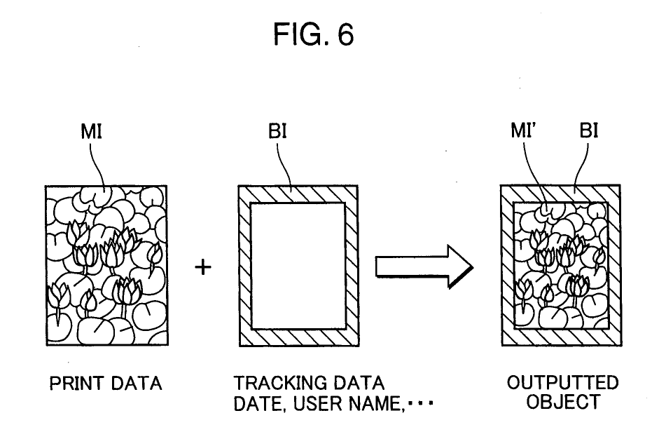

According to the above-described processing, when the latent image embedded background image data and the primary image data are synthesized in the printing system 100, the reducing processing is applied to the primary image data, and then the primary image data the latent image embedded background image data are synthesized. Thereafter, the synthesized image data is transmitted to the image forming apparatus 120 as a printing PDL data. Accordingly, as shown in FIG. 6, for example, the reducing processing is applied to the primary image MI such that a printing result can be obtained in which the reduced primary image MI′ and the latent image embedded background image BI are not superimposed. Further, in FIG. 6, a whole area of the output sheet is depicted as a printable area for ease in depiction.

As described above, according to the present invention, when the primary image data covers a whole area of a printable area of the output sheet, the primary image data is reduced without any superimposition of the latent image embedded background image and the primary image, and the reduced primary image and the latent image embedded background image are printed without any superimposition. Accordingly, the latent image embedded background image concerning a background image which is embedded with a mask image and the primary image are synthesized and outputted without deterioration of image quality of the primary image in an easy and assured manner.

Further, in an example of the printing result shown in FIG. 6, the latent image embedded background image BI is printed in the frame-like area. However, an area where the latent image embedded background image BI is printed is not necessarily the frame-like area. For example, the reduced primary image may be positioned on one side of a printable area of the output sheet, and a margin portion having a U-shape, L-shape, I-shape or the like may be formed on the other side such that the latent image embedded background image is printed in the margin portion.

Further, in the printing system 100, the reducing processing is applied to the primary image data on the side of the client 110, and then the reduced primary image data and the latent image embedded background image data are synthesized. Then, the synthesized image data is transmitted to the image forming apparatus 120 as a printing PDL data. However, instead of applying reducing processing to the primary image data on the side of the client 110, setting information for reducing the printable area of the primary image data may be transmitted with the latent image embedded background image data and the primary image data from the client 110 to the image forming apparatus 120, and then the primary image data may be applied with the reducing processing on the side of the image forming apparatus 120 and synthesized with the latent image embedded background image data so that a similar printing result can be obtained.

### Second Embodiment

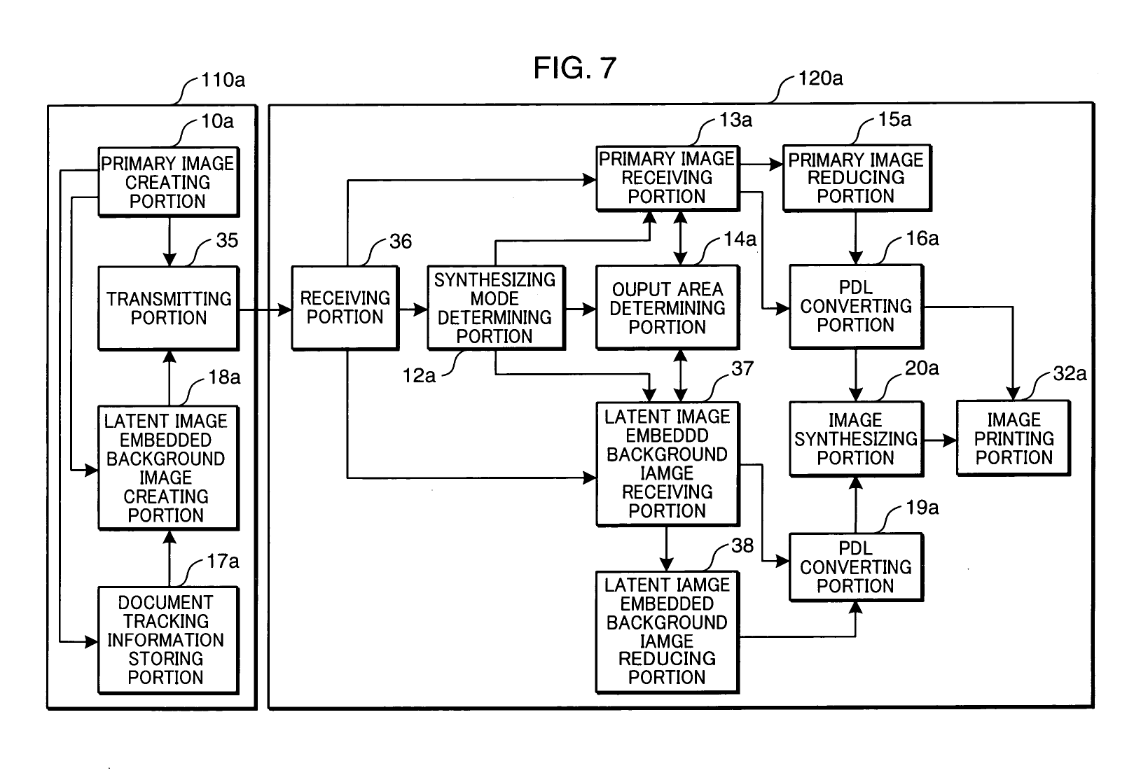

Next, a printing system according to a second embodiment of the present invention will be described. FIG. 7 is a block diagram showing a functional configuration of the printing system according to the second embodiment of the present invention. Since a hardware configuration of the printing system according to the present embodiment is the similar to that of the printing system shown in FIGS. 1 through 3, the printing system will be described with appropriate reference to FIGS. 1 through 3.

As shown in FIG. 7, the client 110a includes a primary image creating portion 10a, a document tracking information storing portion 17a, a latent image embedded background image creating portion 18a and a transmitting portion 35. The image forming apparatus 120a includes a receiving portion 36, a synthesizing mode determining portion 12a, a primary image receiving portion 13a, an output area determining portion 14a, a primary image reducing portion 15a, a PDL converting portion 16a, a latent image embedded background image receiving portion 37, a latent image embedded background image reducing portion 38, a PDL converting portion 19a, an image synthesizing portion 20a and an image printing portion 32a.

The CPU 111 shown in FIG. 2 executes an application program, an operating system and the like to allow the client 110a to serve as a primary image creating portion 10a. Further, the CPU 111 shown in FIG. 2 executes a device driver and the like to allow the client 110a to serve as a document tracking information storing portion 17a, a latent image embedded background image creating portion 18a and a transmitting portion 35.

The CPU 121 shown in FIG. 3 executes a firmware and the like to allow the image forming apparatus 120a to serve as a receiving portion 36, a synthesizing mode determining portion 12a, a primary image receiving portion 13a, an output area determining portion 14a, a primary image reducing portion 15a, a PDL converting portion 16a, a latent image embedded background image receiving portion 37, a latent image embedded background image reducing portion 38, a PDL converting portion 19a, an image synthesizing portion 20a and an image printing portion 32a.

The primary image creating portion 10a of the client 110a creates primary image data and thereafter outputs synthesizing mode setting information with the primary image data. The synthesizing mode setting information indicates whether or not the synthesizing mode of synthesizing the latent image embedded background image and the primary image is set. Further, in a case where the synthesizing mode setting information indicates setting of the synthesizing mode, in other words, the synthesizing mode is set, the primary image creating portion 10a instructs the latent image embedded background image creating portion 18a to create a latent image embedded background image data, and creates document tracking information corresponding to the primary image data and allows the document tracking information storing portion 17a to store the same.

In a case where the primary image is a text document, for example, the primary image creating portion 10a allows the document tracking information storing portion 17a to store document tracking information such as a document name, a printing date, a person who executed the printing and an address of the client 110a (for example, a MAC address). The latent image embedded background image creating portion 18a refers to the document tracking information storing portion 17a to read out the document tracking information and creates a mask image including the document tracking information. Then, the latent image embedded background image creating portion 18a creates a latent image embedded background image data concerning a background image which is embedded with the created mask image as a latent image and outputs the latent image embedded background image data to the transmitting portion 35.

In a case where the synthesizing mode is set, the transmitting portion 35 outputs synthesizing mode setting information indicating that the synthesizing mode is set, the primary image data and the latent image embedded background image data to the receiving portion 36 of the image forming apparatus 120a. On the other hand, in a case where the synthesizing mode is not set, the transmitting portion 35 outputs synthesizing mode setting information indicating that the synthesizing mode is not set and the primary image data to the receiving portion 36 of the image forming apparatus 120a.

In the case where the synthesizing mode is not set, the receiving portion 36 receives synthesizing mode setting information indicating that the synthesizing mode is not set and the primary image data. Then, the receiving portion 36 transmits the synthesizing mode setting information to the synthesizing mode determining portion 12a, and transmits the primary image data to the primary image receiving portion 13a. On the other hand, in a case where the synthesizing mode is set, the receiving portion 36 receives synthesizing mode setting information indicating that the synthesizing mode is set, the primary image data and the latent image embedded background image data. Then, the receiving portion 36 outputs the synthesizing mode setting information to the synthesizing mode determining portion 12a, outputs the primary image data to the primary image receiving portion 13a, and outputs the latent image embedded background image data to the latent image embedded background image receiving portion 37.

The synthesizing mode determining portion 12a determines whether or not the synthesizing mode is set based on the synthesizing mode setting information. In a case where the synthesizing mode is not set, the synthesizing mode determining portion 12a instructs the primary image receiving portion 13a to output the primary image data to the PDL converting portion 16a. The primary image receiving portion 13a outputs the primary image data to the PDL converting portion 16a and instructs the PDL converting portion 16a to output a PDL data to the image printing portion 32a. The PDL converting portion 16a converts the primary image data into a PDL data and outputs the PDL data to the image printing portion 32a. The image printing portion 32a prints the primary image onto an output sheet.

In a case where the synthesizing mode is set, the synthesizing mode determining portion 12a notifies the output area determining portion 14a that the synthesizing mode is set, and instructs the primary image receiving portion 13a to output the primary image data to the output area determining portion 14a or instructs the latent image embedded background image receiving portion 37 to output the latent image embedded background image data to the output area determining portion 14a.

At this time, the output area determining portion 14a determines whether or not a print area of the primary image and a print area of the latent image embedded background image are superimposed in a printable area of an output sheet based on the primary image data transmitted from the primary image receiving portion 13a and the latent image embedded background image data transmitted from the latent image embedded background image receiving portion 37.

In a case where the print area of the primary image and the print area of the latent image embedded background image are not superimposed in the printable area of the output sheet, the output area determining portion 14a instructs the primary image receiving portion 13a to output the primary image data to the PDL converting portion 16a, and instructs the latent image embedded background image receiving portion 37 to output the latent image embedded background image data to the PDL converting portion 19a.

At this time, the primary image receiving portion 13a outputs the primary image data to the PDL converting portion 16a and instructs the PDL converting portion 16a to output a PDL data to the image synthesizing portion 20a. The PDL converting portion 16a converts the primary image data into a PDL data and outputs the PDL data to the image synthesizing portion 20a.

Further, the latent image embedded background image receiving portion 37 outputs the latent image embedded background image data to the PDL converting portion 19a. The PDL converting portion 19a converts the latent image embedded background image data into a PDL data and outputs the PDL data to the image synthesizing portion 20a.

The image synthesizing portion 20a adds the PDL data of the latent image embedded background image to the PDL data of the primary image and outputs the PDL data to the image printing portion 32a. The image printing portion 32a prints the primary image and the latent image embedded background image onto an output sheet without any superimposition of the primary image and the latent image embedded background image.

On the other hand, in a case where a print area of the primary image and a print area of the latent image embedded background image are superimposed in a printable area of an output sheet, the output area determining portion 14a determines whether or not which one of the primary image data and the latent image embedded background image data should be reduced. As a criterion for the determination, for example, the output area determining portion 14a determines that a print area of the primary image should be reduced in a case where a print area of the primary image is larger than a predetermined area (for example, 86% of a printable area), and determines that the latent image embedded background image data should be reduced in other cases.

The criterion for the determination is not especially limited to the above-described example, and various modifications can be made such as determining which one of the primary image data and the latent image embedded background image data should be reduced in accordance with a user's setting or a default value (information indicating reduction of the primary image data or reduction of the latent image embedded background image data) predetermined in the apparatus. Further, the primary image data and the latent image embedded background image data may be reduced at the same reduction rate such that a print area of the primary image and the print area of the latent image embedded background image are not superimposed in a printable area of an output sheet, or both image data may be reduced while making a reduction rate of the primary image data and a reduction rate of the latent image embedded background image data be different from each other.

Further, various values such as 86%, 82%, 71%, and 50% may be adopted as a reduction rate for the primary image data or for the latent image embedded background image data. One reduction rate among these reduction rates is predetermined, and the primary image data or the latent image embedded background image data is reduced at a set reduction rate. Further, the reduction rate may be the same in vertical and horizontal directions, or the reduction may be applied only in any of vertical and horizontal directions.

Further, setting of the reduction rate can be made by allowing a user to use the input portion 116 to set a desirable reduction rate. Further, it may be so configured that the reduction rate is automatically calculated in accordance with sizes of the primary image and the latent image embedded background image such that the primary image and the latent image embedded background image are formed in a whole area of a printable area of an output sheet.

In a case where the output area determining portion 14a determines that the primary image data should be reduced, the output area determining portion 14a instructs the primary image receiving portion 13a to output the primary image data to the primary image reducing portion 15a, and instructs the latent image embedded background image receiving portion 37 to output the latent image embedded background image data to the PDL converting portion 19a.

At this time, the primary image receiving portion 13a outputs the primary image data to the primary image reducing portion 15a. The primary image reducing portion 15a reduces the primary image data at a predetermined reduction rate, outputs the reduced primary image data to the PDL converting portion 16a, and instructs the PDL converting portion 16a to output PDL data to the image synthesizing portion 20a. The PDL converting portion 16a converts the reduced primary image data to PDL data and outputs the PDL data to the image synthesizing portion 20a.

Further, the latent image embedded background image receiving portion 37 outputs the latent image embedded background image data to the PDL converting portion 19a. The PDL converting portion 19a converts the latent image embedded background image data into a PDL data and outputs the PDL data to the image synthesizing portion 20a.

At this time, the image synthesizing portion 20a adds the PDL data of the latent image embedded background image to the PDL data of the reduced primary image and outputs the PDL data to the image printing portion 32a. The image printing portion 32a prints the reduced primary image and the latent image embedded background image onto an output sheet without any superimposition of the reduced primary image and the latent image embedded background image.

On the other hand, when it is determined the latent image embedded background image data should be reduced, the output area determining portion 14a instructs the primary image receiving portion 13a to output the primary image data to the PDL converting portion 16a and instructs the latent image embedded background image receiving portion 37 to output the latent image embedded background image data to the latent image embedded background image reducing portion 38.

At this time, primary image receiving portion 13a outputs the primary image data to the PDL converting portion 16a. The PDL converting portion 16a converts the primary image data into PDL data and outputs the PDL data to the image synthesizing portion 20a.

Further, the latent image embedded background image receiving portion 37 outputs the latent image embedded background image data to the latent image embedded background image reducing portion 38. The latent image embedded background image reducing portion 38 reduces the latent image embedded background image data at a predetermined reduction rate, outputs the reduced image data to the PDL converting portion 19a and instructs the PDL converting portion 19a to output the PDL data to the image synthesizing portion 20a. The PDL converting portion 19a converts the reduced latent image embedded background image data into a PDL data and outputs the PDL data to the image synthesizing portion 20a.

At this time, the image synthesizing portion 20a adds the PDL data of the reduced latent image embedded background image to the PDL data of the primary image and outputs the PDL data to the image printing portion 32a. The image printing portion 32a prints the primary image and the reduced latent image embedded background image onto an output sheet without any superimposition of the primary image and the reduced latent image embedded background image.

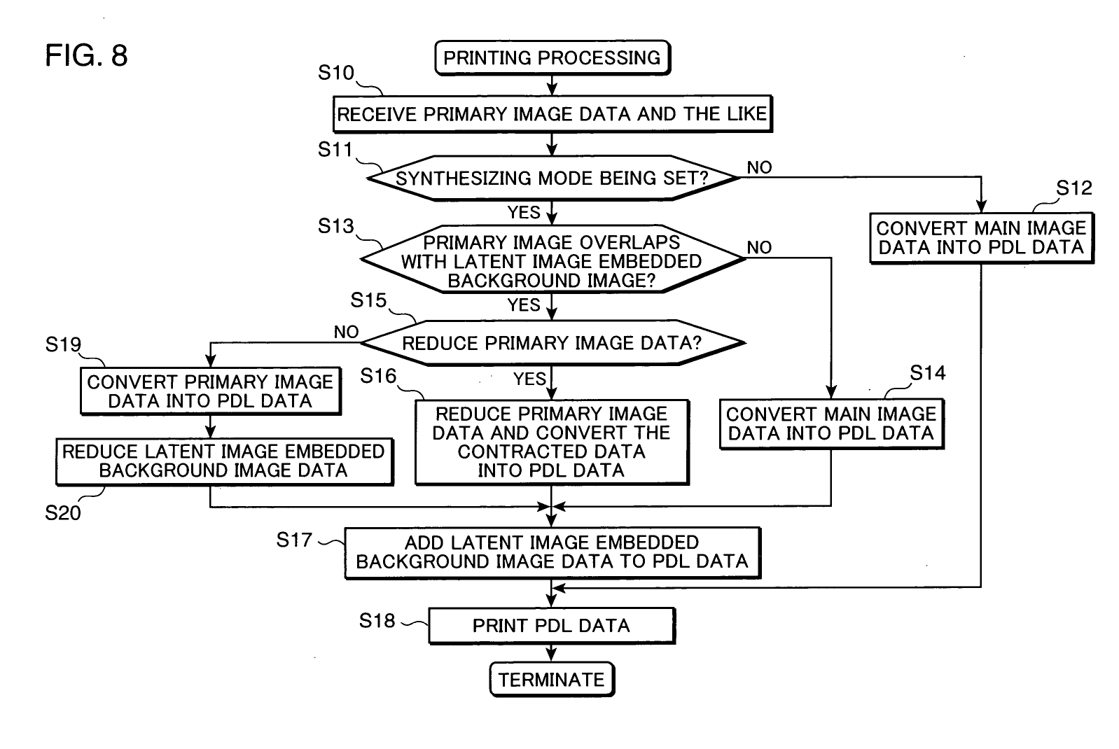

Next, a printing processing (an image forming processing) performed by the image forming apparatus 120a so configured as described above will be described. FIG. 8 is a flowchart showing a printing processing of the image forming apparatus 120a shown in FIG. 7.

As described above, when the client 110a transmits synthesizing mode setting information and primary image data (along with latent image embedded background image data if the synthesizing mode is set), and then the printing processing is started, the receiving portion 36, at first in step S10, receives synthesizing mode setting information and primary image data (along with a latent image embedded background image data if the synthesizing mode is set). Then, the receiving portion 36 outputs the synthesizing mode setting information to the synthesizing mode determining portion 12a, and outputs the primary image data to the primary image receiving portion 13a (outputs latent image embedded background image data to the latent image embedded background image receiving portion 37 if the synthesizing mode is set).

Next, in step S11, the synthesizing mode determining portion 12a determines whether or not the synthesizing mode is set based on the synthesizing mode setting information.

In a case where the determination result in step S11 is “NO”, in other words, the synthesizing mode is not set, in the next step S12, the synthesizing mode determining portion 12a instructs the primary image receiving portion 13a to output the primary image data (document data) to the PDL converting portion 16a, and the primary image receiving portion 13a outputs the primary image data to the PDL converting portion 16a. The PDL converting portion 16a converts the primary image data into a PDL data and outputs the PDL data to the image printing portion 32a. Thereafter, in step S18, the image printing portion 32a prints the primary image onto the output sheet.

In a case where the determination result in step S11 is “YES”, in other words, the synthesizing mode is set, in step S13, the synthesizing mode determining portion 12a notifies the output area determining portion 14a that the synthesizing mode is set. The output area determining portion 14a specifies a print area of the primary image and a print area of the latent image embedded background image based on the primary image data received from the primary image receiving portion 13a and the latent image embedded background image data received from latent image embedded background image receiving portion 37, and determines whether or not the print area of the primary image and the print area of the latent image embedded background image are superimposed in a printable area of the output sheet.

In a case where the determination result in step S13 is “NO”, in other words, the print area of the primary image and the print area of the latent image embedded background image are not superimposed in the printable area of the output sheet, in the next step S14, the primary image receiving portion 13a outputs the primary image data to the PDL converting portion 16a. The PDL converting portion 16a converts the primary image data into a PDL data and outputs the PDL data to the image synthesizing portion 20a. Then, the routine proceeds to step S17.

On the other hand, in a case where the determination result in the step S13 is “YES”, in other words, the printable area of the primary image and the print area of the latent image embedded background image are super imposed on the printable area of the output sheet, the output area determining portion 14a determines in step S15 whether or not the primary image data should be reduced.

In a case where the determination result in step S15 is “YES”, in other words, it is determined that the primary image data should be reduced, the primary image receiving portion 13a outputs the primary image data to the primary image reducing portion 15a. The primary image reducing portion 15a reduces the primary image data at a predetermined reduction rate and outputs the reduced primary image data to the PDL converting portion 16a. The PDL converting portion 16a converts the reduced primary image data into a PDL data and outputs the PDL data to the image synthesizing portion 20a. Then, the routine proceeds to step S17.

On the other hand, in a case where the determination result in the step S15 is “NO”, in other words, it is determined that the latent image embedded background image data should be reduced, the primary image receiving portion 13a outputs the primary image data to the PDL converting portion 16a in step S19. The PDL converting portion 16a converts the primary image data into a PDL data and outputs the PDL data to the image synthesizing portion 20a.

Next, in step S20, the latent image embedded background image receiving portion 37 outputs the latent image embedded background image data to the latent image embedded background image reducing portion 38. The latent image embedded background image reducing portion 38 reduces the latent image embedded background image data at a predetermined reduction rate and outputs the reduced image data to the PDL converting portion 19a. Then, the routine proceeds to step S17.

In the next step S17, the PDL converting portion 19a converts the latent image embedded background image data into PDL data and outputs the converted PDL data of the latent image embedded background image to the image synthesizing portion 20a. The image synthesizing portion 20a adds the PDL data of latent image embedded background image to the PDL data of the primary image converted in step S14, or adds the PDL data of the latent image embedded background image to the PDL data of the primary image reduced in step S16, or adds the PDL data of the latent image embedded background image reduced in step S20 to the PDL data of the primary image converted in step S19 such that latent image embedded background image is positioned at an area outside the print area of the primary image. Then, the image synthesizing portion 20a outputs the PDL data to the image printing portion 32a.

Then, in the next step S18, the image printing portion 32a prints the images onto the output sheet without any superimposition of the primary image (or the reduced primary image) and the latent image embedded background image (or the reduced latent image embedded background image).

According to the above-described processing, when the latent image embedded background image data and the primary image data are synthesized in the image forming apparatus 120a, the reducing processing is applied to the primary image data or to the latent image embedded background image data such that the primary image data and the latent image embedded background image data are synthesized. Accordingly, with use of the synthesized PDL data for printing, a printing result can be obtained in which the primary image and the latent image embedded background image are not superimposed.

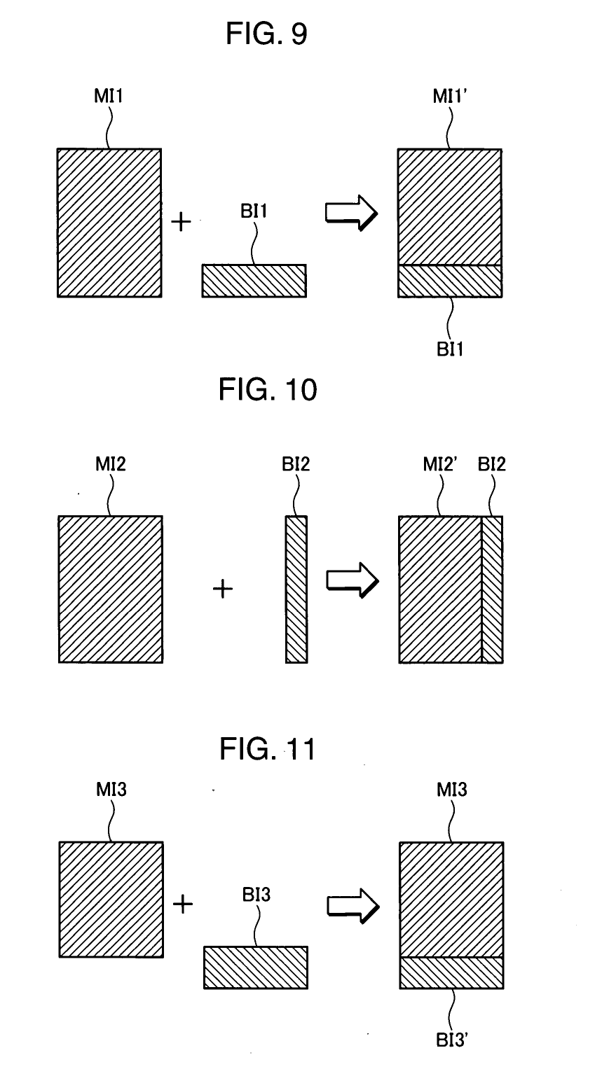

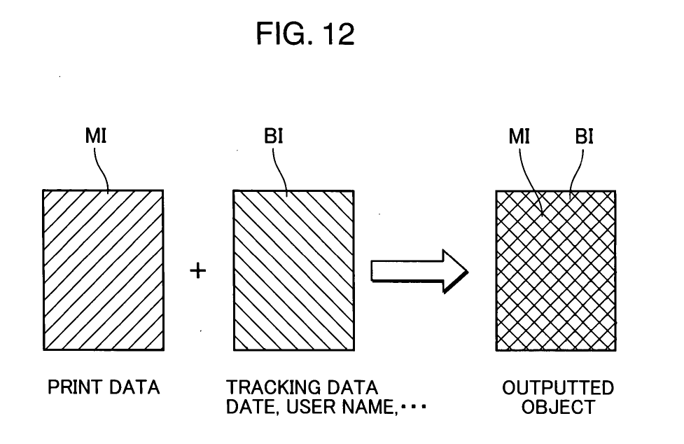

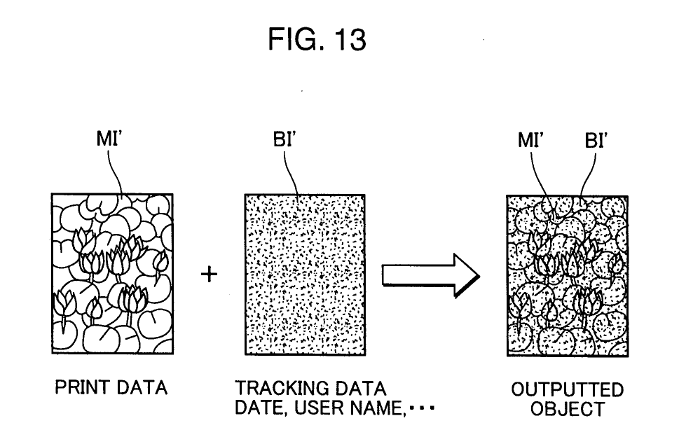

FIGS. 9-.11 show examples of printing results of the cases where the latent image embedded background image and the primary image are synthesized and outputted in the printing system shown in FIG. 7.

In the example shown in FIG. 9, the primary image reducing portion 15a reduces the primary image MI1 in a vertical direction to create a reduced primary image MI1′. The image synthesizing portion 20a places a latent image embedded background image BI1 at the lower side of the reduced primary image MI1′ and synthesizes the images. Accordingly, a printing result can be obtained in which the reduced primary image MI1′ and the latent image embedded background image BI1 are not super imposed. A position of the latent image embedded background image is not especially limited to this example. The latent image embedded background image may be placed at the upper side of the reduced primary image.

In the example shown in FIG. 10, the primary image reducing portion 15a reduces a primary image MI2 in a horizontal direction to create a reduced primary image MI2′. The image synthesizing portion 20a places a latent image embedded background image BI2 at the right side of the reduced primary image MI2′ and synthesizes the images. Accordingly, a printing result can be obtained in which the reduced primary image MI2′ and the latent image embedded background image BI2 are not superimposed. A position of the latent image embedded background image is not especially limited to the above-described example. The latent image embedded background image may be positioned on the left side of the reduced primary image.

In the example shown in FIG. 11, the latent image embedded background image reducing portion 38 reduces a latent image embedded background image BI3 in a vertical direction to create a reduced latent image embedded background image BI3′. The image synthesizing portion 20a places the reduced latent image embedded background image BI3′ on the lower side of the primary image MI3. Accordingly, a printing result can be obtained in which the primary image MI3 and the reduced latent image embedded background image BI3′ are not superimposed. A position of the latent image embedded background image is not especially limited to this example. The reduced latent image embedded background image may be placed on the upper side of the primary image.

As described above, according to the present embodiment, in a case where the primary image and the latent image embedded background image are superimposed, the primary image data and/or the latent image embedded background image data are reduced without any superimposition of the latent image embedded background image and the primary image and printed without any superimposition of the primary image and the latent image embedded background image. Accordingly, a latent image embedded background image concerning a background image which is embedded with a mask image as a latent image and a primary image can by synthesized in an easy and assured manner and outputted without deterioration of image quality of the primary image.

In the present embodiment, primary image data and latent image embedded background image data are created in the client 110a. However, the present invention is not limited to this example. The latent image embedded background image data may be created in the image forming apparatus 120a, and document image data read out in the scanner portion 126 may be used as primary image data.

Further, in the descriptions above, a document is described as an example of a primary image. However, a primary image is not especially limited to this example. Alternatively, the similar effect can be obtained with images such as a picture, a graph, a diagram and a figure.

As described above, an image forming processing apparatus according to one aspect of the present invention comprises: an image processor which synthesizes a latent image embedded background image data concerning a latent image embedded background image which is embedded with a mask image capable of keeping invisible in the process of printing but becoming visible in the process of copying as a latent image and a primary image data concerning a primary image into output data; and a controller which determines whether or not a synthesizing mode of synthesizing the latent image embedded background image and the primary image is set, and controls the image processor to synthesize the primary image data and the latent image embedded background image data without any superimposition of the primary image and the latent image embedded background image when the synthesizing mode is set.

An image forming processing method according to another aspect of the present invention comprises the steps of: determining whether or not a synthesizing mode of synthesizing a latent image embedded background image which is embedded with a mask image capable of keeping invisible in the process of printing but becoming visible in the process of copying as a latent image and a primary image into output data is set, and synthesizing a primary image data concerning the primary image and a latent image embedded background image data concerning the latent image embedded background image without any superimposition of the primary image and the latent image embedded background image when the synthesizing mode is set.

A recording medium according to yet another aspect of the present invention includes a computer-readable recording medium storing an image forming processing program which allows a computer to serve as: an image processor which synthesizes a latent image embedded background image data concerning a latent image embedded background image which is embedded with a mask image capable of keeping invisible in the process of printing but becoming visible in the process of copying as a latent image and a primary image data concerning a primary image into output data; and a controller which determines whether or not a synthesizing mode of synthesizing the latent image embedded background image and the primary image is set, and controls the image processor to synthesize the primary image data and the latent image embedded background image without any superimposition of the primary image and the latent image embedded background image when the synthesizing mode is set.

According to the above-described configurations, it is determined whether or not a synthesizing mode of synthesizing a latent image embedded background image which is embedded with a mask image capable of keeping invisible in the process of printing but becoming visible in the process of copying as a latent image and a primary image is set. When the synthesizing mode is set, the primary image data and the latent image embedded background image data are synthesized into an output data without any superimposition of the primary image and the latent image embedded background image. Accordingly, a latent image embedded background image concerning a background image which is embedded with a mask image as a latent image and a primary image are synthesized in an easy and assured manner without deterioration of image quality of the primary image.

It is preferable that when the synthesizing mode is set, the controller reduces the primary image data and controls the image processor to synthesize the reduced primary image data and the latent image embedded background image data into output data when the synthesizing mode is set.

In this case, when the synthesizing mode is set, the primary image data is reduced, and the reduced primary image data and the latent image embedded background image data are synthesized into output data. Accordingly, the reduced primary image and the latent image embedded background image can be printed without any superimposition of the reduced primary image and the latent image embedded background image.

It is preferable that the controller determines whether or not the primary image covers a whole area of a printable area of an output sheet when the synthesizing mode is set, and the controller reduces the primary image data and controls the image processor to synthesize the reduced primary image data and the latent image embedded background image data into output data when the primary image covers a whole area of a printable area of the output sheet.

In this case, when the synthesizing mode is set, the controller determines whether or not the primary image covers a whole area of a printable area of an output sheet. When the primary image covers a whole area of a printable area of the output sheet, the controller reduces the primary image data and controls the image processor to synthesize the reduced primary image data and the latent image embedded background image data into output data. Accordingly, even in a case where the primary image and the latent image embedded background image are certainly superimposed since the primary image covers a whole area of a printable area of the output sheet, the reduced primary image and the latent image embedded background image can be printed assuredly without any superimposition of the reduced primary image and the latent image embedded background image.

It is preferable that the controller reduces the primary image data in a vertical direction and controls the image processor to synthesize the reduced primary image data and the latent image embedded background image data into output data with positioning of the latent image embedded background image at one of an upper portion and a lower portion of the reduced primary image when the synthesizing mode is set.

In this case, when the synthesizing mode is set, the primary image data is reduced in a vertical direction, and the reduced primary image data and the latent image embedded background image data are synthesized with positioning of the latent image embedded background image at one of the upper portion and the lower portion of the reduced primary image into output data. Accordingly, a space for the latent image embedded background image can be reserved just by reducing the primary image in a vertical direction.

It is preferable that the controller reduces the primary image data in a horizontal direction and controls the image processor to synthesize the reduced primary image data and the latent image embedded background image data into output data with positioning of the latent image embedded background image at one of a left portion and a right portion of the reduced primary image when the image synthesizing mode is set.

In this case, when the image synthesizing mode is set, the primary image data is reduced in a horizontal direction, and the reduced primary image data and the latent image embedded background image data are synthesized with positioning of the latent image embedded background image at one of the right side and the left side of the reduced primary image into output data. Accordingly, a space for the latent image embedded background image can be reserved just by reducing the primary image in a horizontal direction.

It is preferable that the controller determines a print area of the primary image on an output sheet and controls the image processor to synthesize the primary image data and the latent image embedded background image data into output data with positioning of the latent image embedded background image outside the print area of the primary image when the synthesizing mode is set.

In this case, when the synthesizing mode is set, a print area of the primary image on an output sheet is determined, and the primary image data and the latent image embedded background image data are synthesized with positioning of the latent image embedded background image outside the primary image into output data. Accordingly, the latent image embedded background image is positioned in an area outside the print area of the primary image so that the primary image and the latent image embedded background image can be printed without superimposition of the primary image and the latent image embedded background image.

It is preferable that the controller determines a print area of the primary image on an output sheet, reduces the primary image data and controls the image processor to synthesize the reduced primary image data and the latent image embedded background image data into output data with positioning of the latent image embedded background image outside the print area of the primary image when the synthesizing mode is set.

In this case, when the synthesizing mode is set, a print area of an output sheet of the primary image is determined. Further, the primary image data is reduced, and the reduced primary image data the latent image embedded background image data are synthesized with positioning of the latent image embedded background image outside the print area of the image into output data. Accordingly, the latent image embedded background image is positioned outside the print area of the reduced primary image, and the reduced primary image and the latent image embedded background image can be printed without any superimposition of the reduced primary image and the latent image embedded background image.

It is preferable that the controller determines a print area of the primary image on an output sheet, reduces the latent image embedded background image data and controls the image processor to synthesize the reduced latent image embedded background image data and the primary image data into output data with positioning of the latent image embedded background image outside of the print area of the primary image when the synthesizing mode is set.

In this case, when the synthesizing mode is set, a print area of the primary image on the output sheet is determined. Further, the latent image embedded background image data is reduced, and the reduced latent image embedded background image data and the primary image data are synthesized with positioning of the reduced latent image embedded background image at an area outside the print area of the primary image into output data. Accordingly, the reduced latent image embedded background image is positioned in an area outside the print area of the main image, and the primary image and the reduced latent image embedded background image can be printed without any superimposition of the primary image and the reduced latent image embedded background image.

It is preferable that the controller determines a print area of the primary image on an output sheet, reduces the primary image data and the latent image embedded background image data and controls the image processor to synthesize the reduced latent image embedded background image data and the reduced primary image data into output data with positioning of the latent image embedded background image outside the print area of the primary image when the synthesizing mode is set.

In this case, when the synthesizing mode is set, a print area of the primary image on the output sheet is determined. Further, the primary image data and the latent image embedded background image data are reduced, and the reduced primary image data and the reduced latent image embedded background image data are synthesized with positioning of the latent image embedded background image in an area outside the print area of the primary image into output data. Accordingly, the reduced latent image embedded background image is positioned in an area outside the print area of the reduced primary image so that the primary image and the latent image embedded background image can be reduced equally and printed without any superimposition of the reduced primary image and the reduced latent image embedded background image.

It is preferable that the image processor converts the primary image data and the latent image embedded background image data into page description language data and synthesizes the primary image data and the latent image embedded background image data into output data.

In this case, after the primary image data and the latent image embedded background image data are converted into the page description language data and primary image data and the latent image embedded background image data are synthesized into output data. Accordingly, the primary image and the latent image embedded background image can be printed with use of a normal printer or the like without any superimposition of the primary image and the latent image embedded background image.

It is preferable that the image forming processing apparatus further comprises a printing portion which prints the primary image and the latent image embedded background image with use of the primary image data and the latent image embedded background data which are converted into the page description language data and synthesized.

In this case, the latent image embedded background image and the primary image can be printed with use of the primary image data and the latent image embedded background image data which are converted into page description language data and synthesized. Accordingly, the primary image and the latent image embedded background image can be printed without any superimposition of the primary image and the latent image embedded background image.

It is preferable that the mask image includes a document tracking information image concerning document tracking information for tracking an origin of the primary image, and the image processor synthesizes the latent image embedded background image embedded with the document tracking information image as a latent image and the primary image data into output data.

In this case, the latent image embedded background image data concerning a background image which is embedded with the document tracking information image of document tracking information for tracking origin of the primary image as a latent image and the primary image data are synthesized into output data. Accordingly, in a case where the printed latent image embedded background image is copied, the document tracking image is visualized to allow a user to easily confirm the document tracking information. Consequently, unauthorized copying can be easily prevented.

This application is based on Japanese Patent application serial no. 2006-198620 filed in Japan Patent Office on Jul. 20, 2006, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter are defined, they should be construed as being included therein.

What is claimed is:

1. An image forming processing apparatus comprising:
an image processor which synthesizes a latent image embedded background image data concerning a latent image embedded background image which is embedded with a mask image capable of keeping invisible in the process of printing but becoming visible in the process of copying as a latent image and a primary image data concerning a primary image into output data; and
a controller which determines whether or not a synthesizing mode of synthesizing the latent image embedded background image and the primary image is set, and controls the image processor to synthesize the primary image data and the latent image embedded background image data without any superimposition of the primary image and the latent image embedded background image when the synthesizing mode is set.

2. The image forming processing apparatus according to claim 1, wherein the controller reduces the primary image data and controls the image processor to synthesize the reduced primary image data and the latent image embedded background image data into output data when the synthesizing mode is set.

3. The image forming processing apparatus according to claim 2, wherein:
the controller determines whether or not the primary image covers a whole area of a printable area of an output sheet when the synthesizing mode is set, and
the controller reduces the primary image data and controls the image processor to synthesize the reduced primary image data and the latent image embedded background image data into output data when the primary image covers a whole area of a printable area of the output sheet.

4. The image forming processing apparatus according to claim 2, wherein the controller reduces the primary image data in a vertical direction and controls the image processor to synthesize the reduced primary image data and the latent image embedded background image data into output data with positioning of the latent image embedded background image at one of an upper portion and a lower portion of the reduced primary image when the synthesizing mode is set.

5. The image forming processing apparatus according to claim 2, wherein the controller reduces the primary image data in a horizontal direction and controls the image processor to synthesize the reduced primary image data and the latent image embedded background image data into output data with positioning of the latent image embedded background image at one of a left portion and a right portion of the reduced primary image when the image synthesizing mode is set.

6. The image forming processing apparatus according to claim 1, wherein the controller determines a print area of the primary image on an output sheet and controls the image processor to synthesize the primary image data and the latent image embedded background image data into output data with positioning of the latent image embedded background image outside the print area of the primary image when the synthesizing mode is set.

7. The image forming processing apparatus according to claim 1, wherein the controller determines a print area of the primary image on an output sheet, reduces the primary image data and controls the image processor to synthesize the reduced primary image data and the latent image embedded background image data into output data with positioning of the latent image embedded background image outside the print area of the primary image when the synthesizing mode is set.

8. The image forming processing apparatus according to claim 1, wherein the controller determines a print area of the primary image on an output sheet, reduces the latent image embedded background image data and controls the image processor to synthesize the reduced latent image embedded background image data and the primary image data into output data with positioning of the latent image embedded background image outside of the print area of the primary image when the synthesizing mode is set.

9. The image forming processing apparatus according to claim 1, wherein the controller determines a print area of the primary image on an output sheet and reduces the primary image data and the latent image embedded background image data, and controls the image processor to synthesize the reduced latent image embedded background image data and the reduced primary image data into output data with positioning of the latent image embedded background image outside the print area of the primary image when the synthesizing mode is set.

10. The image forming processing apparatus according to claim 1, wherein the image processor converts the primary image data and the latent image embedded background image data into page description language data and synthesizes the primary image data and the latent image embedded background image data into output data.

11. The image forming processing apparatus according to claim 10, further comprising a printing portion which prints the primary image and the latent image embedded background image with use of the primary image data and the latent image embedded background data which are converted into the page description language data and synthesized.

12. The image forming processing apparatus according to claim 1, wherein:
the mask image includes a document tracking information image concerning document tracking information for tracking an origin of the primary image, and
the image processor synthesizes the latent image embedded background image embedded with the document tracking information image as a latent image and the primary image data into output data.

13. An image forming processing method comprising the steps of:
determining whether or not a synthesizing mode of synthesizing a latent image embedded background image which is embedded with a mask image capable of keeping invisible in the process of printing but becoming visible in the process of copying as a latent image and a primary image into output data is set, and
synthesizing a primary image data concerning the primary image and a latent image embedded background image data concerning the latent image embedded background image without any superimposition of the primary image and the latent image embedded background image when the synthesizing mode is set.

14. A computer-readable recording medium storing an image forming processing program which allows a computer to serve as:
an image processor which synthesizes a latent image embedded background image data concerning a latent image embedded background image which is embedded with a mask image capable of keeping invisible in the process of printing but becoming visible in the process of copying as a latent image and a primary image data concerning a primary image into output data; and
a controller which determines whether or not a synthesizing mode of synthesizing the latent image embedded background image and the primary image is set, and controls the image processor to synthesize the primary image data and the latent image embedded background image without any superimposition of the primary image and the latent image embedded background image when the synthesizing mode is set.
